(19) United States
(12) Patent Application Publication
(10) Pub. No.: US 2008/0312978 A1
(43) Pub. Date: Dec. 18, 2008

(54) System and Mechanism for Proactive Supplier Hub Management

(76) Inventors: Blair A. Binney, Marlboro, NY (US); Markus R. Ettl, Yorktown Heights, NY (US); Shubir Kapoor, Shrub Oak, NY (US); Rajesh Kumar Ravi, Croton On Hudson, NY (US); Sarah Elizabeth Santo, Poughkeepsie, NY (US); Young-Jun Yoon, Newburgh, NY (US)

Correspondence Address: Whitham, Curtis, & Christofferson, P.C., Suite 340, 11491 Sunset Hills Road, Reston, VA, 20190, US

(21) Appl. No.: 11/761,593

(22) Filed: Jun. 12, 2007

(51) Int. Cl. G06Q 10/00; G06F 17/10; G06Q 99/00

(52) U.S. Cl. 705/7

(57) ABSTRACT

A system and method for allowing an organization access to supplier data, allows an organization which has outsourced one or more supply functions to one or more suppliers, permits feeding in real-time data from suppliers and processing and analyzing the data to determine performance metrics. Monitoring of these performance metrics against thresholds, which are established periodically based on customer data and forecast data, allows for the generation of alerts when the thresholds have been exceeded. This may occur, for example, when a supplier contract may have been violated or when new controls may need to be enforced within the contracts. Corrective actions may be taken in response to alerts, and these actions may modify previously established performance metrics and provide for recalculating the performance metrics with the new data.

### BACKGROUND OF THE INVENTION

1. Field of the Invention

The present invention generally relates to managing the procurement of supply for a manufacturing organization across its multi-tiered outsourced supply partners and more particularly, to a method and mechanism for providing real-time control and quality monitoring of the outsourced manufacturing activities related to procurement of supply.

2. Background Description

In order to lower costs and streamline business operations, many manufacturing organizations have outsourced their operations or parts of their operations to contract manufacturers. Even though this business model lowers costs and shifts responsibility of maintaining customer serviceability on to the outsourced partner, it requires additional visibility and control actions to be implemented by the original manufacturing organization to allow for managing and auditing supplier contracts. Ultimately, it is optimum serviceability at the cost of lower inventory costs that can be extracted out of the extended supplier chain that benefit the bottom line and help increase revenue.

Many organizations that have moved to an outsourcing model have found that managing a complex web of value chain partners without building the correct visibility and control modules have resulted in numerous problems. One such problem is higher inventory liabilities at the end of management periods requiring the original manufacturer to purchase unused parts that were originally forecasted but could not be matched with actual demand. Another problem is sub-optimal serviceability at the cost of higher inventory costs or reduced customer satisfaction. Higher costs caused by reduced visibility over the extended supply chain have also been a resulting problem. Additionally, communications in a timely and accurate fashion between the supplier and the original manufacturer has been a problem.

### SUMMARY OF THE INVENTION

One solution to the above-described problems is to maintain a hub configuration between the supplier and the organization. This hub is a virtual warehouse of items and/or components that can be provided by the various suppliers. However, just maintaining this hub does not alleviate all of the associated problems of outsourcing the manufacturing process. The hub is a way to centralize the information but the management of the information and the monitoring of the process are still necessary.

It is therefore an exemplary embodiment of the present invention to provide a system and method to exchange real-time data between the at least one of a plurality of suppliers and the organization and to correlate and analyze this data to develop performance indicators that are used to manage the just in time manufacturing and supply process.

Another exemplary embodiment of the present invention is to provide pro-active alerts highlighting areas where the supplier and/or suppliers' contracts have been violated or new controls need to be enforced within the contracts.

Yet another exemplary embodiment of the present invention is to provide an inventory optimization capability to recommend the optimum levels of parts in the hub which result in maximizing order fulfillment while minimizing the inventory liability.

An additional exemplary embodiment of the present invention is to support supplier data visibility and tracking purposes between the organization and the one or more suppliers either directly or in a tiered configuration.

According to the invention, there is provided a computer-implemented method for receiving customer orders from one or a plurality of customers. The customer orders are analyzed and a short-term order trend is generated indicating potential future demand over a given time period. As part of the sales and operational planning of most organizations, there also exists a computer implemented method of sharing demand forecasts with the suppliers. There also exists a computer-implemented method for receiving supply information from one or a plurality of suppliers. The supplier information (e.g., inventory, receipts, lead time, supply commits, etc.) in combination with the order trend is analyzed and a recommendation is generated for an optimum inventory level to be maintained in the hub. Additional performance indicators are also developed for monitoring the contract, specifically the inventory of parts held in the hub resulting in an agreed upon serviceability between the organization and the one or more suppliers of the required part. These performance indicators are quantifiable measurements that reflect the critical success factors of the business and are typically used to measure the progress toward meeting the organizations goals such as but not limited to on-time delivery and serviceability. A monitoring capability based on thresholds specified in the contractual agreements with the suppliers provides alerts that enable corrective action during the process of the end-to-end supply chain. Display and reporting capabilities allow real-time access to data throughout the manufacturing process.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a business level description of the process.

FIG. 2 is a diagram of the major elements of the system.

FIGS. 3A-C provide sample reports.

FIG. 4 provides a high level flow chart for the supplier hub management method.

FIG. 5 is a schematic drawing showing thresholds for performance indicators.

FIG. 6 provides a detailed flow chart for the inventory optimization step.

### DETAILED DESCRIPTION OF THE PREFERRED EMBODIMENTS OF THE INVENTION

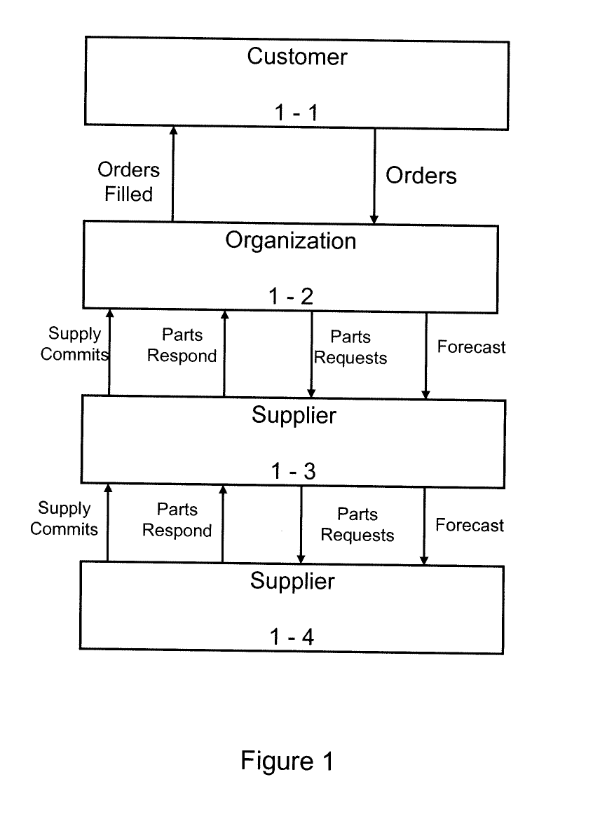

Referring now to the drawings, and more particularly to FIG. 1, there is shown a business process for receiving manufacturer orders of a customer 1-1. In this figure, the customer 1-1 is shown as a single entity; however, those skilled in the art should easily understand that the method can accommodate multiple customers. The customer 1-1 provides an order to the organization 1-2. This organization is the manufacturing organization that has outsourced some or all of its manufacturing capabilities to one or more suppliers 1-3 and 1-4. These suppliers (1-3 and 1-4) can be subdivisions within an organization and/or may be separate corporate entities. In addition, FIG. 1 shows only two suppliers (1-3 and 1-4); those skilled in the art will understand that end to end supply chain can include a plurality of suppliers in either a tiered structure (i.e., relationship of organization 1-2 to supplier 1-4 is through supplier 1-3), direct structure (i.e., relationship of organization 1-2 is directly with supplier 1-3) and/or some combination of tiered and direct relationships between the organization 1-2 and the possible plurality of suppliers. The organization 1-2 has the order contract with the customer 1-1 and is required to fill the orders within the limitations of the contract as to delivery time, price, quality, etc. In order to meet this contract, the organization 1-2 has contracted with one or more suppliers (1-3 and 1-4) without limitation to the structure of the contract, that is tiered or direct or some combination thereof for the order item or components of the order item.

The organization 1-2 periodically issues forecasts to the suppliers for specific numbers of items or components based on the anticipated demand over a fixed time horizon. The supplier 1-3 (or suppliers 1-3 and 1-4) respond back to the organization 1-2 (or the tier above them) with a supply commit statement indicating the parts or components that they would have available based on the forecast. The organization 1-2 has sufficient knowledge of the parts or components that would be available over a forward looking time period thereby enabling them to plan for promotions and marketing campaigns as well as predicting the expected availability and ship date for all advanced future orders from the customer 1-1. The organization 1-2 also periodically issue requests for parts based on orders received from the customer 1-1. The supplier 1-3 (or suppliers 1-3 and 1-4) respond to the request for parts with a replenishment of parts if the inventory falls below an accepted threshold. This allows the organization 1-2 to fulfill the customer order and transfer the item to customer 1-1. Those skilled in the art will also understand that supplier 1-4 may produce piece parts for supplier 1-3. These part parts are then manufactured by supplier 1-3 and/or the organization 1-2 to produce the goods order by the customer 1-1.

Frequently, this direct flow through situation usually results in shortfalls due to lead time in manufacturing of individual piece parts, and manufacturing of ordered goods, etc. It is more common for an organization 1-2 to have standing contracts with suppliers (1-3 and 1-4) based on sales forecast of potential orders from one or more customers 1-1. The suppliers 1-3 and 1-4 and the organization 1-2 must exchange forecast data in order to monitor and manage the order fulfillment.

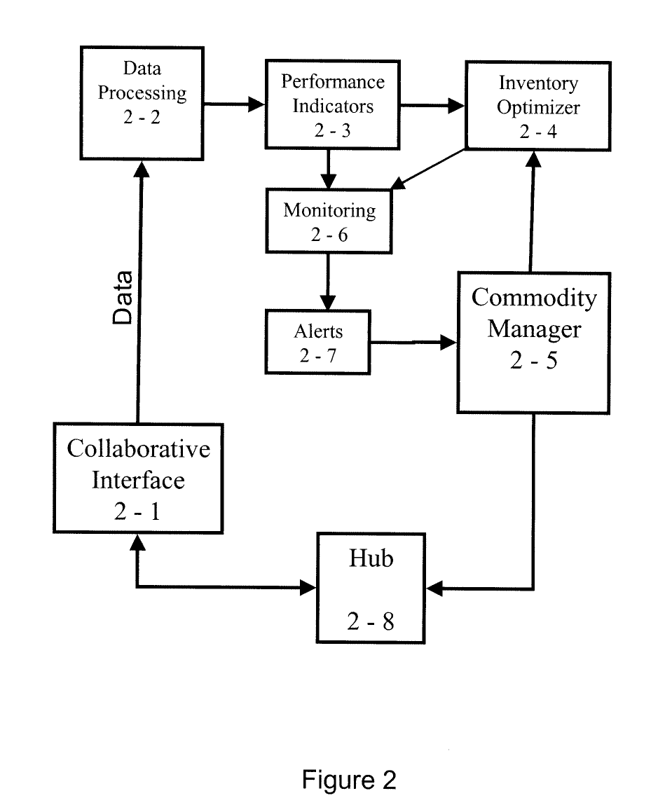

FIG. 2 provides a system level diagram of the elements of the proactive supplier hub management system. Data is received at the Collaborative Interface 2-1 (one or more computers or processors of the organization 1-2 (FIG. 1) which the organization uses to interact with both customers and suppliers). The data may be input from any one of a plurality of sources to include but not be limited a manual input of data through some keyboard like device or similar capability or can be transferred electronically through a network or may be exchanged between some type of storage capability or database. The data is that information required by the organization from the supplier (or suppliers) and expresses the contents of the suppliers' warehouse functions in terms of inventory of parts and/or goods available, supply commits, lead times, parts requests from the organization 1-2 and receipts back to the organization 1-2 etc. This data is maintained in an electronic hub 2-8 and includes transactional hub data. Hub data is that information which defines the inventory levels, lead times and parts requests and receipts of the items and/or components, etc. that are maintained by each of the suppliers in the end-to-end supply chain. As mentioned previously, the hub (2-8) is a virtual warehouse or database which maintains the current inventory and potential inventory of the various suppliers that have contracts with the organization either directly or indirectly. Each of the possible plurality of suppliers may not have direct contracts with the organization, but the contracts between suppliers with direct contracts to the organization which have contracts with indirect suppliers would require the indirect suppliers to provide that data requested by the organization as part of the data for maintaining the virtual hub 2-8.

Once the data is received from the collaborative interface 2-1, the data processing function 2-2 cleanses, analyzes, transforms and detects anomalies in the data in terms of but not limited to supply commits, lead time, inventory, and receipts.

The performance indicators element 2-3 calculates the business metrics against which the system will monitor performance such as but not limited to days of supply, order variance, forecast average, skew, run rate, etc. Performance Indicators are business metrics that are calculated based on well defined expressions. For example, the days of supply indicator can be calculated by taking an average of the first 6 weeks of forecast. The formula is—

$$\frac{{\sum }_{CW - 1}^{CW + 4} HubForecast}{3}$$

The runrate is an average of the receipts (which is the number of parts received from the supplier) across all the weeks in the current quarter. The expression is—

$${\sum }_{i = 1}^{CW - 1} {Receipts}_{i} / N$$

where N is the number of the weeks elapsed in the current quarter and CW is current week
ForecastAverage is the average of actual receipts received from the supplier for the elapsed weeks in the current quarter and the open forecast weeks in the current quarter. This expression is

$$( {\sum }_{i = CW}^{N} {HubForecast}_{i} + {\sum }_{i = i}^{CW - 1} Receipts ) / N$$

where N is the number of weeks in the current quarter and CW is the current week.
Forecast Accuracy measures the accuracy of the last 13 weeks of forecast by comparing it to the actual parts received from the hub for the same weeks of execution. The expression is

$${\sum }_{i = CW - 1}^{CW - 13} ( \frac{\vert {HubReceipts}_{i} - {HubForecast}_{i} \vert}{{HubForecast}_{i}} ) / 13$$

where CW is the current week.
These performance indicators are computed weekly with every refresh of the forecast and updates received from the supplier through the collaborative interface 2-1.

The inventory optimizer 2-4 uses the business metrics generated by the performance indicators element 2-3 to dynamically generate a minimum and maximum threshold level indicating the optimum quantity of parts to keep in the hub as per the supplier contract. The inventory optimizer 2-4 is an analytical routine (using non-linear optimization) for calculating the min and max thresholds.

The max/min inventory thresholds generated by the Inventory Optimizer 2-4 along with the business metrics calculated by the performance indicators 2-3, are input to the monitoring sub-system 2-6 which monitors the hub 2-8 data to determine if the inventory data received from the collaborative interface 2-1 and stored in the hub 2-8, has crossed the min and max thresholds. The inventory thresholds are generated by the inventory optimizer 2-4. Inventory thresholds can be changed periodically (e.g., daily, weekly, etc.) based on customer orders and supplier data. To avoid excessive chum in the supply chain and constant updates to the supply contracts, this is performed optimally based on proactive monitoring of the forecast and more specifically monitoring of the forecast average performance indicator. A change in the current forecast average above a specific tolerance of the forecast average generated the week the Inventory min/max thresholds were generated indicates a need to re-run the inventory optimizer and regenerate new inventory min/max thresholds. The supplier hub inventory received via the collaborative interface 2-1 is monitored against these thresholds. If the inventory falls below or above the thresholds, an alert is generated.

If a threshold is exceeded as minimum or maximum, the alerts 2-7 sends an alarm to the commodity manager function 2-5. The commodity manager function 2-5 sends reports to the organization which indicate the areas causing the alarms.

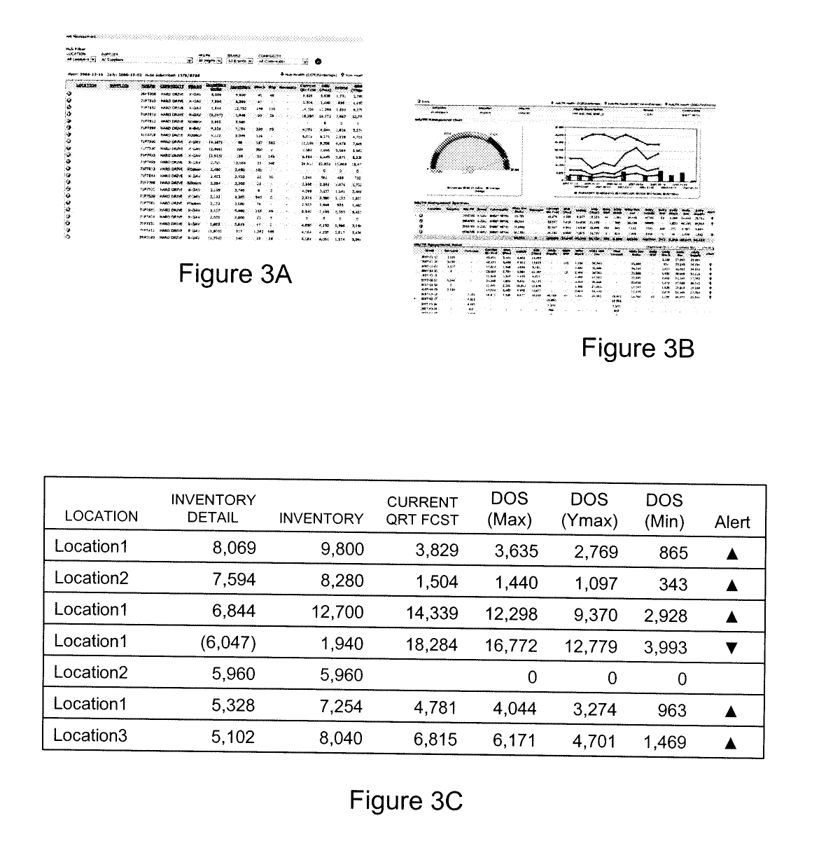

FIG. 3 provides examples of reports that could be generated to present the alert status of the hub inventory. FIGS. 3A and 3C are snap shots of how the reports might look. Those skilled in the art would understand the multitude of different reports that would be able to be provided from the information available within the hub. FIG. 3C is an excerpt from the example report shown in FIG. 3A. FIG. 3C shows the location of the different parts (and/or manufacturer) warehouses identified as location. Looking at the inventory detail, inventory and the minimum and maximum thresholds (Inventory (Max) and Inventory (Min), respectively), it is shown that for the first location of parts (i.e. Location1), the inventory is 9,600 while the Inventory (Max) threshold is 3,635. That is, the inventory exceeds the established maximum threshold and an alert is indicated by the upward arrow. Likewise, for the third hub at Location1, the inventory is shown as 1,940 while the Inventory (Min) has been established as 3,993. Therefore, the required inventory has fallen below the established minimum threshold and again, an alert is indicated, this time with a downward arrow. The arrow notations, or other suitable indicators, show when there is an overage or underage of supply capability relative to the inventory held in the hub, and can indicate the performance indicator for a supplier is too high or too low. This information will be used by the organization to notify one or more suppliers to take corrective actions to bring the performance indicators within the threshold ranges. Notification can be performed automatically over a network (e.g., WAN, LAN, Internet, etc.). In FIGS. 3a-c, for example, the number of hard drives of particular types made by particular suppliers are shown with respect to an alert status. FIGS. 3a-c are an example and those skilled in the art would understand the multitude of different reports that would be able to be provided from the information available within the hub.

Referring again to FIG. 2, the organization modifies the contracts or takes other corrective action and the new data is entered in to the system. The commodity manager function 2-5 can modify the inventory optimizer 2-4 thresholds based on the new input data. Thus, the process continues and corrections are handled in a real-time fashion. That is, the system not only allows monitoring of the inventory levels of the virtual hub but the system also enables a proactive modification of the inventory levels through management of thresholds and contractual changes, either new or modified contracts.

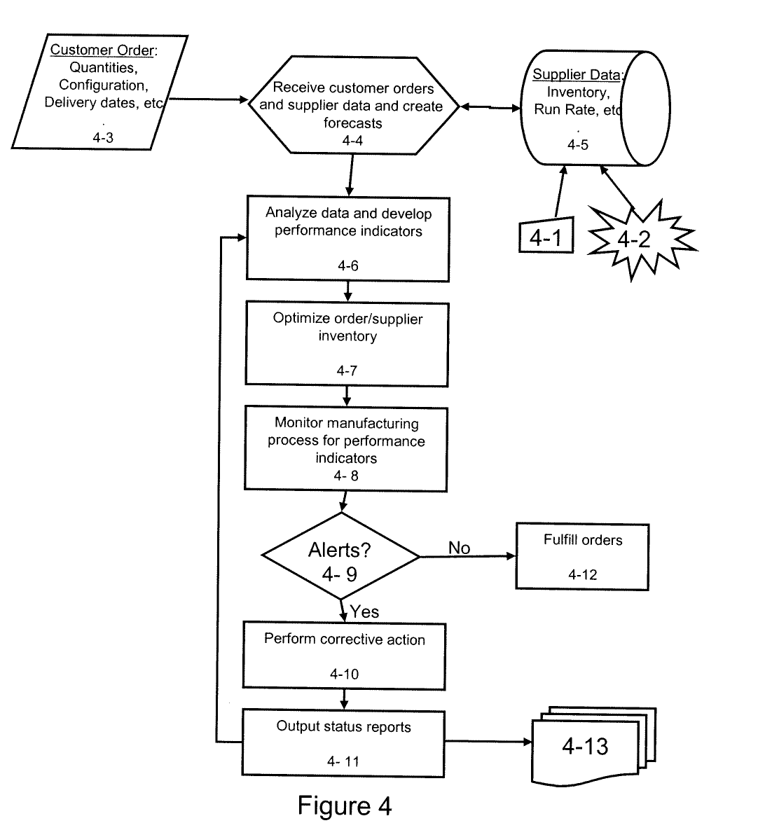

The method performed by this system is described in the flow chart of FIG. 4. As described for FIG. 2, the data used as the input to the system can be entered manually (4-1) or be received through a network (4-2). This data is maintained in a database (4-5). The database (4-5) may be configured as a single storage element or a collection of distributed storage capabilities located across a network. Customer order data (4-3) is received which includes but is not limited to quantities, configurations, delivery dates, delivery locations, and price, etc. The customer order and supplier data are received at step (4-4) and forecasts are created which reflect potential customer orders and supplier capabilities. The data is analyzed at step (4-6) and performance indicators are developed. The performance indicators are quantifiable measurements that reflect the critical success factors of a business and are typically used to measure progress towards the organizational goals and can provide valuable input on whether the business is on track to meet the defined objectives. Using the performance indicators, the invention develops optimized inventory thresholds at step (4-7) which define maximum and minimum inventory levels for the virtual hub. These thresholds are developed by considering the current supply levels and order requirements as well as the forecasted requirements relative to the performance indicators.

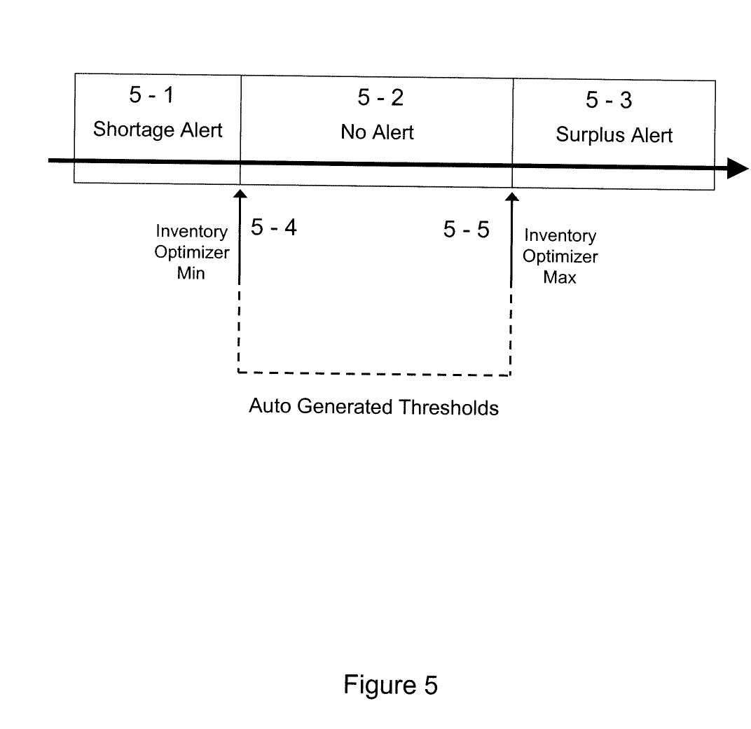

FIG. 5 presents a simplified drawing showing a first zone 5-1 indicative of a shortage alert, a second zone 5-2 where no alert is required, and a third zone 5-3 indicative of a surplus. The inventory optimizer generated Min 5-4 and Max 5-5 thresholds can be generated on a dynamic basis according to a desired schedule (e.g., daily, weekly, monthly, etc.) If the inventory falls below or above the thresholds Min 5-4 and Max 5-5, an alert is generated (see, e.g., FIG. 3). FIG. 5 illustrates only example of an application of the invention, i.e., having thresholds generated based on the forecast to optimally set the supply hub inventory—this enables synchronization between demand and supply.

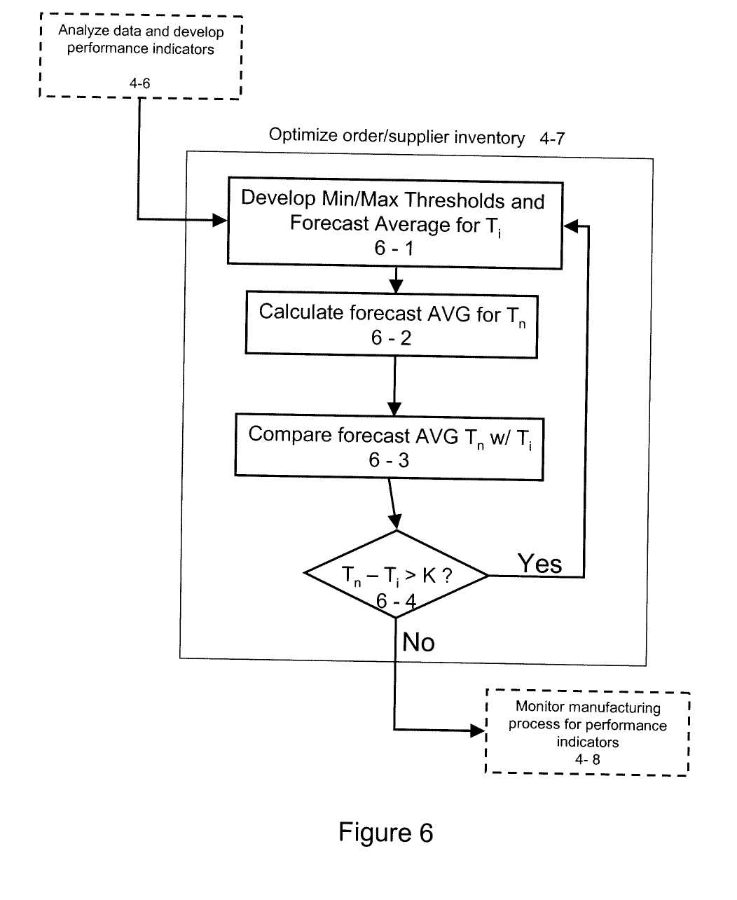

These thresholds can be dynamically set either at pre-determined intervals (e.g., weekly, bi-weekly, etc.) or when forecast information has changed significantly as described in FIG. 6. As part of the develop performance indicators (step 4-6), a forecast average tolerance (K) can be determined. This tolerance may be a set percentage relative to the performance indicators levels or may be a pre-determined value entered by the organization (1-2). Upon initialization of the system, the maximum and minimum thresholds are developed for the initial week (or other suitable time period) (step 6-1). The ability to dynamically generate these thresholds on a weekly basis, for example, requires that the initial thresholds be defined relative to the initial week Tᵢ where i=1. Forecast average is then calculated relative to the current week Tₙ where n=1, 2, . . . n (step 6-2). For the initial week, n=i. After the initial week, new forecasts are developed based on new order requests as well as supplier data. The forecast average at Tᵢ are compared to the forecast average at Tₙ at step 6-3. Step 6-4 performs the test, if the difference between the forecast average performance indicator values at Tᵢ and Tₙ is greater than the tolerance (K) then a new min/max threshold is developed and current week Tₙ is reinitialized as Tᵢ. If the difference at step 6-4 does not exceed the tolerance K, the system progresses to step 4-8. The process has been described using the interval “week,” however, those skilled in the art will understand that the interval can be different from a week such as but not limited to bi-weekly, monthly, etc.

Returning to FIG. 4, once the thresholds have been set, the invention monitors the hub data to ensure that the supplier inventory volumes have not exceeded the thresholds (step 4-8). Assuming all contracts are in place at appropriate delivery levels, the invention would not provide an alert (step 4-9) and orders would continue to be filled (4-12). However, if performance indicator thresholds were reached, the invention would provide an alert at step (4-9). For example, if a new order is received by the organization, the commodity manager may update the forecast and require additional inventory. The system would acknowledge the change as an alert that the minimum inventory level currently set would be reached before all orders could be fulfilled. An alert would sent at step (4-9) and a corrective action would be performed at step (4-10). The corrective action might include but not be limited to a change in an existing supplier contract to increase manufacturing levels of a particular piece part or the initiation of a new contract to provide the additional items.

After the corrective action was performed, a status reports would be provided at step (4-11). These reports (4-13) could be in the form of printed document and/or could be updates in the inventory levels of the hub with notifications to the commodity manager function. The invention would continue to analyze supplier hub data as well as forecast data from the organization to determine any changes and would update the performance threshold as appropriate.

While the invention has been described in terms of its preferred embodiments, those skilled in the art will recognize that the invention can be practiced with modification within the spirit and scope of the appended claims.

1. A method for providing proactive business performance capabilities to monitor and manage inventories in supplier hubs, comprising the following steps:
receiving one or more customer orders and supplier inventory data from one or more suppliers;
creating forecast data, using a computer or processor, based on said one or more customer orders;
developing one or more performance indicators based on an analysis of said customer orders, said supplier data and said forecast data, said one or more performance indicators being related to manufacturing processes of said one or more suppliers;
establishing inventory optimization thresholds as min and max thresholds using said performance indicators;
monitoring said supplier inventory data for said performance indicators;
generating an alert when inventory optimization thresholds are exceeded, said alert allowing corrective action to be performed.

2. The method of claim 1 wherein said one or more performance indicators includes a days of supply indicator.

3. The method of claim 1 wherein said one or more performance indicators includes a runrate for a specified time interval.

4. The method of claim 1 wherein said one or more performance indicators includes a forecast average indicator.

5. The method of claim 1 wherein said one or more performance indicators includes a forecast accuracy indicator.

6. The method of claim 1 wherein said step of establishing inventory optimization thresholds is performed multiple times at periodic intervals.

7. The method of claim 1 wherein said monitoring step includes said one or more suppliers communicating via a network said supplier inventory data.

8. The method of claim 1 further comprising providing one or more reports for each alert generated in said generating step.

9. A system for providing proactive business performance capabilities to monitor and manage inventories in supplier hubs, comprising the following:
a collaborative data interface to manage the flow of data through firewall boundaries to and from one or more suppliers;
a data processing module, operating on one or more computers or processors, to allow for cleansing, transformation and detecting anomalies in the data;
a performance indicator module, operating on said one or more computers or processors, that can be configured to meet performance indicators individually for every supplier;
an inventory optimizer module, operating on said one or more computers or processors, that recommends said performance indicators for every supplier;
a monitoring module, operating on said one or more computers or processors, for monitoring the performance indicators;
an alerting module, operating on said one or more computers or processors, that generates alerts when inventory optimization thresholds are exceeded, said alert allowing corrective action to be performed.

10. The system of claim 9, further comprising a commodity manager module, operating on said one or more computers or processors, which determines one or more corrective actions in the event an alert is generated by the alerting module.

11. The system of claim 9, further comprising a supplier hub module for maintaining a database of all the inventory related data.

12. A computer readable medium having instructions for providing proactive business performance capabilities to monitor and manage inventories in supplier hubs, said instructions encoding the steps of:
receiving one or more customer orders and supplier inventory data from one or more suppliers;
creating forecast data based on said one or more customer orders;
developing one or more performance indicators based on an analysis of said customer orders, said supplier data and said forecast data, said one or more performance indicators being related to manufacturing processes of said one or more suppliers;
establishing inventory optimization thresholds as min and max thresholds using said performance indicators;
monitoring said supplier inventory data for said performance indicators; and
generating an alert when inventory optimization thresholds are exceeded, said alert allowing corrective action to be performed.

13. The computer readable medium of claim 11 further comprising instructions for providing one or more reports for each alert generated.

14. The computer readable medium of claim 11 wherein said instructions for establishing inventory optimization thresholds allow for establishing inventory optimization thresholds dynamically.
